(19) United States
(12) Patent Application Publication
(10) Pub. No.: US 2015/0258711 A1
(43) Pub. Date: Sep. 17, 2015

(54) METHOD FOR PRODUCING COMPOSITE MATERIALS

(71) Applicant: BAYER MATERIAL SCIENCE AG, Monheim Am Rhein (DE)

(72) Inventors: Ulrich Grosser, Kurten (DE); Klaus Horn, Dormagen (DE); Thomas Grimm, Koln (DE); Eckhard Wenz, Koln (DE)

(73) Assignee: BAYER MATERIALSCIENCE AG, Leverkusen (DE)

(21) Appl. No.: 14/429,060

(22) PCT Filed: Sep. 18, 2013
(86) PCT No.: PCT/EP2013/069372

§ 371 Date: Mar. 18, 2015

(30) Foreign Application Priority Data
Sep. 21, 2012 (EP) 12185463.2

(51) Int. Cl. B29B 15/10; B05D 3/12; B05D 3/02

(52) U.S. Cl. CPC B29B 15/10; B05D 3/0254; B05D 3/12; B29K 2105/089

(57) ABSTRACT

The invention relates to a continuous method for producing, by using microparticles, thermoplastics provided with reinforcement fibres. The production methods relate to such composite materials, which contain the reinforcement fibres in a parallel (or predominantly parallel) arrangement in the thermoplastic matrix.

The invention relates to a continuous process for producing thermoplastics provided with reinforcing fibres via use of microparticles. The production methods relate to composite materials which comprise the reinforcing fibres ordered in parallel (or predominantly parallel) arrangement in the thermoplastic matrix.

It is well known that the mechanical, thermal and other properties of polymers, e.g. thermoplastic polymers, can be altered via embedding of reinforcing fibres; various production methods have also been described for such composites, and are also used in industry. By way of example, linear profiles reinforced by continuous-filament fibres and having a thermoplastic matrix can be produced by drawing continuous-filament reinforcing fibres through an impregnation bath in which the thermoplastic has been dissolved in a solvent. Once the residual solvent has been removed from the impregnation product, a continuous-filament-fibre-reinforced linear profile with thermoplastic matrix is obtained, in which the arrangement of the reinforcing fibres is parallel. Another possibility is powder impregnation, in which—after application of thermoplastic powders to the reinforcing fibres—the monofilaments of the reinforcing fibre strand are impregnated via inciting of the thermoplastic.

In principle, it is possible to draw the continuous reinforcing-fibre bundle directly through a thermoplastic melt in order to achieve impregnation. However, a fundamental difficulty here is that the viscosities of the molten thermoplastics are relatively high at melt temperatures lower than those at which the thermoplastic undergoes chemical alteration or indeed decomposes, and therefore the quality of impregnation and the properties of the resultant composite are often unsatisfactory.

EP 56 703 B1 describes a possible method for producing thermoplastic fibre-reinforced linear profiles by means of a melt pultrusion process. A characterizing feature here in pultrusion technology is that the fibre strand is first impregnated and then the fibre/matrix ratio is established. The latter is achieved by way of example by stripping to remove excess polymer at a calibration die.

JP 2008-302595 discloses a production process for composite sheets in which a mat comprising a thermoplastic fibre and/or comprising a pulverulent thermoplastic, and also comprising an inorganic filler, is laminated.

US 2009/0155522 A1 describes lightweight, fibre-reinforced thermoplastic composites with improved toughness, heat resistance and flexibility. In this context, the production of prepregs is also disclosed. Thermoplastic powders are used here, and are applied to the fibres of the prepreg via sintering. Polypropylene powders with an average diameter of 250 pin are mentioned as example.

US 2006/0137799 A1 discloses thermoplastic composite materials with sound-absorbing properties. These materials are composed of various fibres, and the production process for a composite here can involve addition of a resin (binder resin) prior to the thermal treatment of the composite sheet. The resin (binder resin) can be added in the form of powder, flakes, foam, liquid or granules. However, nothing is said here about requirements that have to be placed on the application of the resin in order to ensure that the composite materials are produced smoothly and that products are of good quality.

EP 1 770 115 describes a process for producing a fibre-reinforced, thermoplastically processable, semifinished sheet where a thermoplastic polymer is mixed with reinforcing fibres and hot-pressed to give the semifinished product. In one embodiment here, polymer granules are milled to give powder, this is dispersed in water, the dispersion is mixed with reinforcing fibres, and the mixture is dried and hot-pressed to give the semifinished product.

US 2003/538357 A1 relates to a process for producing composite sheets with use of a pulverulent organic material.

The latter documents are based on use of a thermoplastic powder.

DE 691 07 203 T2 describes a process for the impregnation of fibres which uses particles preferably measuring <250. However, in the process described the particles are not melted and pressed into the fibre, but instead the particles take the form of an aerosol, where the aerosol is produced by using a fluidized bed and the process in particular requires no calibration and also permits very regular impregnation.

US 1986/4626306 describes a process which can use fine particles to impregnate unidirectional fibres, by passing the fibres through a bath comprising particles. The particles measure from 5 to 25 μm.

WO 02/068356 describes a method for the sizing of fibre rovings with the aid of thermoset powder particles. The average particle size is from 1 to 60 μm, preferably from 10 to 30 μm, particularly preferably from 15 to 20 μm.

EP 0 885 704 B1 describes a process which describes the production of carbon fibre prepregs which are mainly composed of thermoset resins, where the particles made of thermoplastic resin make up less than 20% of the weight of the entire prepreg. It is also said that the thermoplastic particles must measure <150 μm, since otherwise the thickness of the composite material to be produced becomes greater than necessary, and physical properties are thus impaired.

Current processes for producing composite materials, also known as organopanels, based on prepreg technology have a plurality of stages composed of the following process steps:
milling of granules to give powder
sieving of the powders
production of the powder prepregs
pressing of the powder prepregs to give organopanels.

The expression “prepreg for organopanels” means a drapable semifinished fibre product preimpregnated with thermoplastic matrix material (e.g. woven fabric, laid scrim, non-woven, or the like).

Suitable mills are used for the milling of the granules to give powder. By way of example, pin mills or vibratory mills are often used for this purpose. The types of comminution mechanism predominant in the process vary, depending on the type of mill, but the plastic is mostly comminuted via friction or impact. Production of fibre-reinforced semifinished products (organopanels) generally uses engineering thermoplastics. Many of these engineering thermoplastics (e.g. PA, PP, PC, PET, PEEK, PPS) have very ductile behaviour even under conditions that involve impact, and a consequence of this in the milling process is that the materials undergo flexing instead of fracture, or can even undergo melting caused by generation of heat. Plastics of this type must be cooled during the milling process by liquid nitrogen or CO₂, sometimes to below −196° C., so that they undergo brittle fracture during the milling process. This additional cooling step incurs high (energy) costs for the entire process, and greatly reduces cost-effectiveness.

The production of powder prepregs for organopanels according to the prior art requires use of powders with particular grain size ranges. To this end, the powder produced is classified through various sieves in a step downstream of the milling process. For reasons of process yield and also of suitability for processing, preferred ranges lie between 200 μm and 500 μm.

The thermoplastic in powder form is then applied to a woven fibre fabric, laid fibre scrim, fibre non-woven or the like, and is melted by introducing heat. Subsequent cooling causes the plastic to adhere on the fibre, and the composite (“prepreg”) can be wound up and subsequently further processed.

Metering equipment is used here to determine how much powder is scattered onto the woven fibre fabric. This is the ultimate deciding factor determining the ratio between fibre and matrix in the subsequent organopanel. The scattering machinery from Schilling-Knobel GmbH is an example of typical metering systems. Suitability of different types of machinery depends on substrate or substrate shape or substrate size. A decisive factor in the metering step is uniform distribution of the polymer matrix on the woven fibre fabric, in order to ensure that homogeneous and complete impregnation is achieved in the subsequent organopanel component. It is therefore not possible to use granulated thermoplastic materials of the shape and size that is available commercially for injection-moulding or extrusion applications (diameter about 3-5 mm), since either the proportion polymer would be significantly too high or else, if the metered amount is smaller, impregnation of the fibres would be inadequate.

Various methods for producing polymer granules are known to the person skilled in the art. One possibility inter alia is that water- or air-cooled polymer strands are extruded and are comminuted in a downstream pelletizer. In an alternative possibility, pellets are produced directly at the die plate via underwater pelletization, an expression used in this instance being die-face pellets. For the purposes of the invention, it has been found that specifically die-face pellets of defined shape and size are particularly suitable for producing continuous-filament-fibre-reinforced thermoplastic linear profiles, despite the fact that the current standard process here uses pulverulent thermoplastics.

The specific properties of organopanel materials are determined to a major extent by the fibre material and matrix material used and the proportions by volume of these. The number and arrangement of the fibre layers and matrix layers in the organopanel is also of decisive importance. The latter parameters are established after prepreg production. For a manufacturing process in a continuous or semi-continuous press, the powder prepregs previously produced and wound up are arranged in a defined manner and simultaneously drawn at a constant advance rate into a heating and pressure zone. In the first region of the press, the prepreg layers are heated at constant pressure. The processing temperatures are generally from 200 to 300° C. The cooling zone is in the second region of the press. The cooling of the organopanels here is sufficient to freeze the matrix material, which holds the fibre material in shape.

Processing speed can vary from <5 m/h to >30 m/h, depending on material, number of layers and the technology of the system. The most important objective for successful conduct of a process is complete impregnation of the fibres. In order to achieve this, temperature and production speed must be set appropriately, and it is the viscosity of the matrix material that is the most influential factor here.

All of the production methods known hitherto for organopanels based on prepegs have the disadvantage that the powders have large scatters and that the milling process is very complicated and for some polymers must by way of example be carried out with nitrogen cooling, incurring high energy cost. Because the powder used is produced in an upstream process step via the milling of thermoplastic granules, the ground substrate generally has very wide grain size scatter. The grain size distribution extends from very small particles (<1 μm) to very large particles (>1000 μm). Substrates with this type of wide grain size scatter are completely unsuitable fir the prepreg production process. The intermediate step of sieve extraction is therefore carried out. Here, suitable sieves are used to achieve the best possible separation of the fine and coarse fractions from the rest of the substrate. However, it is found in practice that complete separation—specifically from the fine fraction is not possible. A major disadvantage of the said fine fraction during the further course of the process is severe contamination of the processing machinery, and very complicated cleaning. In processes conducted under very unfavourable conditions, the proportion of rejected material (fine and coarse fraction) can moreover be up to 50%.

Another cause of contamination of plant is the geometry of the powder particles, which is very irregular, with many edges and acute angles. The flowability of powders of this type is therefore poor. However, good flowability is very important for the prepreg production process, since it eliminates the risk of substrate blockage, which could interrupt a continuous metering process, and thus interrupt the prepreg production process.

Although the design of the apparatuses is intended to minimize cross-contamination, the particulate materials therefore form deposits which make a changeover of powder types significantly more difficult, since the previous type of powder is contaminating the equipment. Requirements for reduced contamination risk during changeover to another type of particulate material are increasingly frequently encountered. In addition, fine dust in the atmosphere is not only a cause of significant loss of material but also in principle creates a dust explosion risk, since operations relatively close to the metering machinery use high temperatures OR sources).

The use of powders therefore has the disadvantage of requiring complicated grinding procedures with low yields to arrive at a powder with an average particle size of from 200 to 500 μm, the grains of which have sharp edges and comprise a fine fraction. In the prior art there is no established process described in detail for producing organopanels above the said limit of 500 μm. In the range below 500 μm, there is no cost-effective alternative to the powder. Furthermore, as grain size decreases production cost rises and yield falls, making a process increasingly uneconomic. There was therefore a requirement for a cost-effective process which also can use an increased grain size. This process should moreover also permit uniform distribution of the thermoplastic, in order to achieve a uniform melting rate.

It was therefore an object of the present invention to provide a process which makes the entire process for producing continuous-filament-fibre-reinforced linear profiles more cost-effective and more economic. Another object was to provide a production process which has been optimized for the use of the specific particles and which permits faster changeover of material with lower cleaning cost.

Surprisingly, it has been found that thermoplastics with a particular geometry cause less cross-contamination of the systems and therefore permit easier changeover between different batches, and can therefore give equally good or even increased quality of product at lower personnel cost.

Surprisingly, it has also been found that thermoplastics of higher grain size can be used if the grains have this particular geometry, and that this also leads to better distribution of the polymer on the surface.

The invention provides a process for producing a continuous-filament-fibre-reinforced composite-material profile or strip, characterized in that at least one thermoplastic is used in the form of almost spherical microparticles.

The almost spherical microparticles according to the invention are characterized in that at least 80%, preferably 90%, particularly preferably 95%, have a contour angle of >90°, preferably >105°, particularly preferably >120°.

It is preferable that the spherical microparticles are also characterized in that at least 80%, preferably 90%, particularly preferably 95%, have a maximum diameter smaller than or equal to 2000 μm, preferably smaller than or equal to 1700 μm, particularly preferably smaller than or equal to 1300 μm. It is preferable that at least 80%, preferably 90%, particularly preferably 95%, of the particles have a maximum diameter in the range greater than or equal to 100 μm, particularly preferably greater than or equal to 200 μm, with particular preference greater than or equal to 400 μm.

Spherical microparticles are characterized in the following way:

The geometry is defined via two-dimensional graphical evaluation on the basis of micrographs of the microparticles or powder particles. The ideal particle geometry in plan view here is a circular cross section. The maximum deviation from the ideal geometry is determined by using suitable chords to provide approximation and measurement of regions in which the outline of the particle has a large amount of discontinuity. (Chord is the term used for that section of a secant that is within the outline of the particle (see FIG. 3)). For the measurements presented, the lengths of the chords are 15.6% of maximum particle diameter D, and therefore if the internal angle between two adjacent chords is 162° the outline of the particle in this region is by definition almost circular. The more the angle decreases below the said value, the greater is the deviation of the outline of the particle from the idea circular shape.

The selection of the suitable chord length is achieved by taking a unit circle with radius r=1. The circle is divided into 20 segments of equal size, and each element therefore corresponds to an 18° segment of the circle (see FIG. 3).

The resultant relationship between radius r and chord length s, obtained by way of the trigonometric relationships, is therefore

$$s = r \cdot \frac{sin ( α )}{cos ( \frac{α}{2} )} where α = 18 ° and r = \frac{D}{2} thus giving : s = D \cdot 0.156$$

where D is the maximum particle diameter or the maximum dimension of the particle.

Spherical microparticles are preferably produced via underwater pelletization. Here, a compounding unit, e.g. a twin-screw kneader (TSK), is first used to mix the thermoplastic material at the temperature of a melt. The size of the TSKs can vary, depending on the desired throughput of material. At the outlet of the compounding unit there is a die plate through which the thermoplastic melt is forced. In the water bath downstream thereof, the melt is very rapidly solidified, and is converted to finished form by rotating knives. Suitable die plates are provided by Gala (Xanten, Germany). The selection of the die plate in particular is a decisive factor for the size of the spherical microparticles and for the resultant suitability for subsequent production of organopanels. It has proved advantageous to use die plates with hole diameters smaller than or equal to 1500 μm, preferably smaller than or equal to 1000 μm, particularly preferably smaller than or equal to 600 μm. Another factor of crucial importance for production of the spherical microparticles according to the invention, alongside the selection of the die plate, is the appropriate frequency of cutting by the rotating knives. The selection of the appropriate frequency of cutting of, or rotation rate of, the rotating knives depends primarily on the number of blades, the size of the die plate, the number of holes in the die plate, the water temperature, the processing temperature of the polymer, the quantitative throughput, and the polymer used. By way of example, production of a PC ABS blend used a die plate with 32 holes each measuring 0.5 mm with a processing temperature of 280° C. and a throughput of 18 kg/h of material. Spherical microparticles according to the invention were then produced with a water temperature of 90° C. and with a rotating knife having 7 blades at a rotation rate of 4000 rpm.

Production of microparticle prepregs is analogous to the process for powder prepregs, except that when spherical microparticles are used it is also possible to use conventional metering equipment for correspondingly greater ranges of grain size. The said metering equipment is used in a manner that depends on the semifinished fibre product used and on the desired properties of the subsequent semifinished product, to establish the fibre content by volume by way of the amount of the spherical microparticles metered into the system. Usual contents of fibre by volume are in the range from 30 to 70% by volume, preferably from 40 to 60% by volume, particularly preferably from 45 to 55% by volume. The metering of materiel into the system is a continuous process and takes place at room temperature. As soon as the spherical microparticles have been metered onto the semifinished fibre product, and are present in “unconsolidated” form on the upper side of the semifinished fibre product, the material passes through the heating zone of the prepreg plant. The setting of the radiant heaters here should be such as to heat the matrix material to the recommended temperatures for processing by injection moulding, so that it melts and adheres on the semifinished fibre product. Examples of temperature ranges for various PC-based thermoplastics are given below.

For pure PC, the said temperatures are in the range from 270 to 320° C., preferably from 280 to 310° C., particularly preferably from 290 to 300° C.

For PC-ABS blends, the said temperatures are in the range from 240 to 300° C., preferably from 250 to 290° C., particularly preferably from 260 to 270° C.

For PC-PET blends, the said temperatures are in the range from 250 to 300° C., preferably from 260 to 290° C., particularly preferably from 270 to 280° C.

For PC-PBT blends, the said temperatures are in the range from 240 to 300° C., preferably from 250 to 290° C., particularly preferably from 260 to 270° C.

In order to maintain the quality of the thermoplastic material, it is advantageous to minimize the period of exposure to thermal stress. This control is achieved in the process primarily via the advance velocity of the prepreg and the power consumed in the radiant source field; these must be adjusted individually in accordance with polymer type or the specific heat capacity of the polymer, the selected proportion of matrix by volume, and the semifinished fibre product used. It has proved advantageous to set the period of exposure to thermal stress to be smaller than or equal to 5 min, preferably smaller than or equal to 3 min, particularly preferably smaller than or equal to 1 min This can be achieved by way of example in the case of a PC-based thermoplastic combined with a semifinished glass-fibre product with a width of 1 m and a weight per unit area of 600 g/m² if the fibre content by volume to be achieved is 50% by volume by using a radiant source field measuring 1 m² with a nominal power consumption of at least 5.2 kW, and adjusting the advance velocity of the prepreg to 0.03 m/s.

After the incipient melting of the matrix material on the semifinished fibre product, the entire composite cools, and can be wound up in the form of microparticle prepreg, and subsequently further processed.

Production of organopanels based on microparticle prepregs is analogous to the production process based on powder prepregs. For a manufacturing process in a continuous or semi-continuous press, the microparticle prepreg previously produced and wound up are arranged in a defined manner and simultaneously drawn into a heating and pressure zone at a constant advance rate. In the first region of the press, the prepreg layers are heated under constant pressure.

In a manner similar to that encountered in the production of the microparticle prepregs, the amount of heating power to be introduced, and the exposure time, are highly dependent on the matrix material used, on the fibre material used, and primarily on the individual layer structure and number of microparticle prepregs. Examples of temperature ranges for various PC-based thermoplastics are mentioned below.

For pure PC, the said temperatures are in the range from 270 to 320° C., preferably from 280 to 310° C., particularly preferably from 285 to 295° C.

For PC-ABS blends, the said temperatures are in the range from 240 to 300° C., preferably from 250 to 290° C., particularly preferably from 265 to 280° C.

For PC-PET blends, the said temperatures are in the range from 250 to 300° C., preferably from 260 to 290° C., particularly preferably from 270 to 285° C.

For PC-PBT blends, the said temperatures are in the range from 240 to 300° C., preferably from 255 to 290° C., particularly preferably from 270 to 280° C.

The period of exposure to the temperature ranges described must be selected in such a way that on the one hand good impregnation of the fibres is ensured, but on the other hand the exposure period is not excessively long, thus causing degradation of the matrix material. It has proved advantageous for the exposure period for the thermoplastics described in the temperature ranges mentioned to be from 5 to 20 min, preferably from 8 to 15 min, particularly preferably from 10 to 13 min.

The thermoplastic matrix of composite materials according to the invention can very generally be composed of a very wide variety of thermoplastic materials, it is essential that the thermoplastic has a lower softening range or lower melting point than the material of which the reinforcing fibres are composed. Examples of materials that can be used are thermoplastics in the widest sense, i.e. substances which exhibit reversible or intermediate thermoplastic behaviour, e.g. thermoplastics and thermoplastic phases of thermosets.

All thermoplastically processable materials are suitable for the purposes of the invention, examples being polyolefins, in particular polypropylene (PP) and polyethylene (Ph), vinyl polymers, for example polyvinyl halides, polyvinyl esters, polyvinyl ethers, polyacrylates, polymethacrylates, in particular polymethyl methacrylate (PMMA), polyamides, in particular nylon-6 and -6,6, and also -12, thermoplastic polyurethanes, polyureas, polyimides, polyesters, in particular polyethylene terephthalate (PET) and polybutylene terephthalate (FBI), poly-ethers, polystyrenes, syndiotactic polystyrene, polyhydantoins, polyphenylene oxides, polyphenylene sulphides, polysulphones, polycarbonates, in particular BPA polycarbonates, BPA/TMCBPA copolycarbonates and siloxane/BPA copolycarbonates, polyester polycarbonates, acrylonitrile-butadiene-styrene (ABS), acrylate-styrene-acrylonitrile (ASA), phenolic resin precursors, furan resin precursors, melamine resin precursors, epoxy resin precursors, compounds having double bonds capable of polymerization and/or of polyaddition, polyimide precursors, polyether ketones, polyether sulphones, polyetherimides, polyamideimides, polyfluoroalkenes, polyester carbonates and liquid-crystal polymers, and also organic cellulose esters and moreover non-polar thermoplastic polymers (e.g. polyolefins) comprising grafted-on polar groups.

It is also possible to use mixtures of the thermoplastic materials mentioned, composed of two or more components.

One preferred embodiment uses amorphous thermoplastics, in particular polycarbonates, in particular BPA polycarbonate, BPA/TMCBPA copolycarbonates and siloxane/BPA copolycarbonates, polyester polycarbonates, and also mixtures of these with polyester, in particular polyethylene terephthalate (PET) and polybutylene terephthalate (PBT), and also mixtures of these with acrylonitrile-butadiene-styrene (ABS) and acrylate-styrene-acrylonitrile (ASA).

The parallel-ordered reinforcing fibres involve continuous reinforcing fibres which can by way of example take the form of individual fibres (monads), rovings, strands, yarns, threads or cords. The diameters of the individual filaments are preferably in the range from 0.5 to 50 μm. The expression continuous reinforcing fibres and, respectively, filaments means those which generally have a length that corresponds approximately the length of the linear profile, or the strip, to be produced.

The reinforcing fibres can be used in the form of continuous-filament fibres in the form of woven fabrics, laid scrims, and braids, and in the form of long fibre in the form of random fibre mats or of non-wovens. For the purposes of this invention, preference is given to use of woven fabrics, laid scrims, and non-wovens.

The reinforcing fibres can have a very wide variety of chemical structure. The only essential feature is that the reinforcing fibres have a higher softening point or melting point than the respective thermoplastic matrix present. Examples of fibre materials are inorganic, materials, such as silicatic and non-silicatic glasses of a very wide variety of types, carbon, basalt, boron, silicon carbide, metals, metal alloys, metal oxides, metal nitrides, metal carbides, silicates, and also organic materials, such as natural and synthetic polymers, for example polyacrylonitriles, polyesters, ultra-high-draw polyolefin fibres, polyamides, polyimides, aramids, liquid-crystal polymers, polyphenylene sulphides, polyether ketones, polyether ether ketones, polyetherimides, cotton and cellulose. Preference is given to high-melting-point materials, such as glasses, carbon, aramids, basalt, liquid-crystal polymers, polyphenylene sulphides, polyether ketones, polyether ether ketones and polyetherimides. Particularly preferred reinforcing fibres are glass fibres and carbon fibres.

### DESCRIPTIONS OF FIGURES

FIG. 1 is a diagram of a flow box used to measure the flowability of powders and spherical microparticles

FIG. 2 shows the parameters for the mechanical bending tests

FIG. 3 shows the division of the unit circle into segments of equal size and shows the outline angle used to characterize the powder particles and microparticles

FIG. 4 shows an enlarged plan view of a spherical microparticle (spherical microparticle #1)

FIG. 5 shows an enlarged plan view of two spherical microparticles (spherical microparticles #2, #3)

FIG. 6 shows an enlarged plan view of two spherical microparticles (spherical microparticles #4, #5)

FIG. 7 shows an enlarged plan view of two powder particles (powder particles #1, #2)

FIG. 8 shows an enlarged plan view of a powder particle (powder particle #3)

FIG. 9 shows an enlarged plan view of two powder particles (powder particles #4, #5)

FIG. 10 shows an enlarged plan view of a large number of spherical microparticles

FIG. 11 shows an enlarged plan view of a large number of powder particles

### EXAMPLES

### Production of Experimental Samples (Prepregs and Organopanels)

The organopanels produced in the present invention were produced by using prepreg technology. To this end, powders and microparticles were first produced from Bayblend T65XF in commercially available granule form.

### Production of Polymer Powder

The Bayblend T65XF powder was produced by using a Malvern Hydro 2000S counter-rotating pin mill. Commercially available Bayblend T65 XF (PC/ABS blend, Vicat B120=120° C.) was cooled and milled by this method. The rotation rates of housing and door rotor were set to 8500 rpm. Good results were achieved with a process setting where the temperature of the material at the outlet from the mill was −25° C. Liquid nitrogen was used as coolant. The powders obtained were sieved and classified for further processing. The classification from 100 to 400 μm was preferably used to produce the prepregs.

### Production of Spherical Microparticles

The microparticles made of Bayblend T65 XF were produced with the aid of a twin-screw extruder with screw diameter 25 mm. Commercially available Bayblend T65 XF (PC/ABS blend, Vicat B120=120° C.) was re-extruded by this method, using a melt temperature of 280° C. and a throughput of 18 kWh. An underwater pelletizer from Gala (Xanten, Germany) was used as pelletizing system to produce the microparticles. A die plate with 32 holes each measuring 0.5 mm was used here to shape the microparticles at the melt outlet. The microparticles were solidified at 90° C. in contact with water directly after discharge from the die, and were chopped by a rotating knife (7 blades) at 4000 rpm. The microparticles were then dried in a downstream centrifugal drier and dispensed.

### Production of Prepregs and Organopanels:

Woven fabric used for the organopanels comprised Hexcel HexForce 1038 (twill 2/2, 600 g/m²) woven glass fibre fabric. The prepregs were produced as described in the prior art. The prepreg system from the Institute for Composite Materials (M) in Kaiserslautern was used for this purpose. The temperature zones for producing the prepregs were set as follows:
heating zone 1=255° C.
heating zone 2=265° C.
heating zone 3=275° C.

Prepreg production using polymer powder and using spherical microparticles used the same process settings in each case. The organopanels were in each case produced by pressing four layers of prepregs in a static press. The pressure applied was set to a constant 25 bar. The press was heated to a processing temperature of 260° C. and held for about 15 min. The press was then cooled back to room temperature. Finally, specimens for bending tests were cut out from a defined region in the centre of the organopanels.

### Experimental Results

### Flow Tests

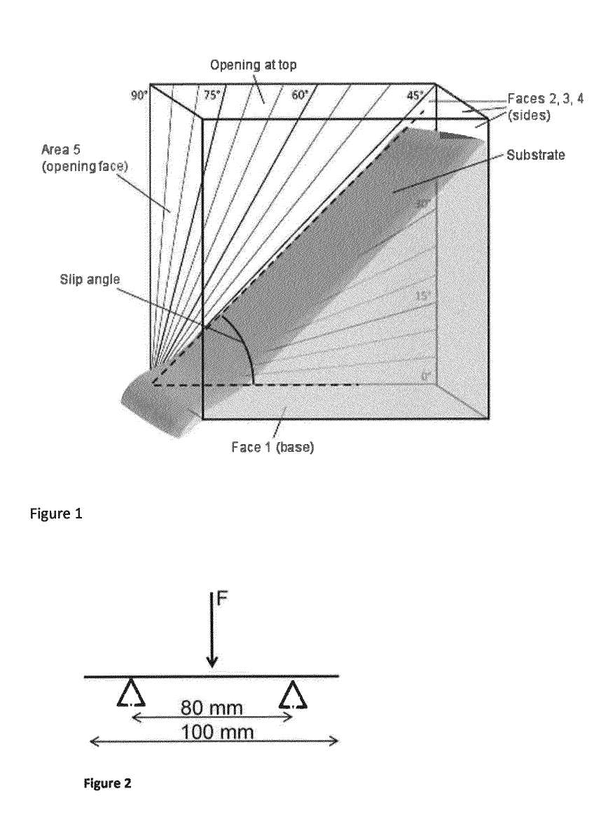

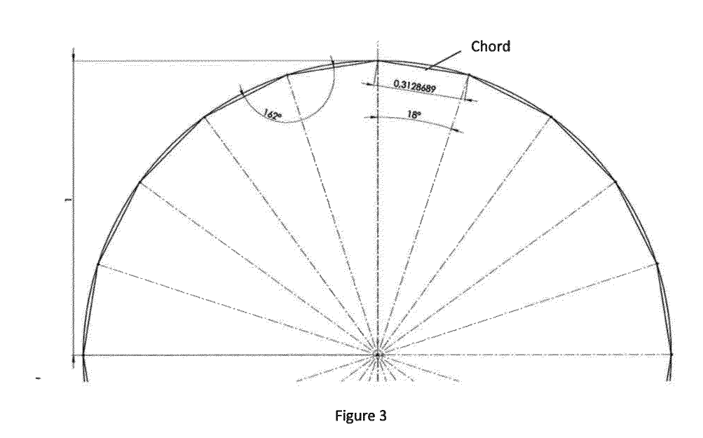

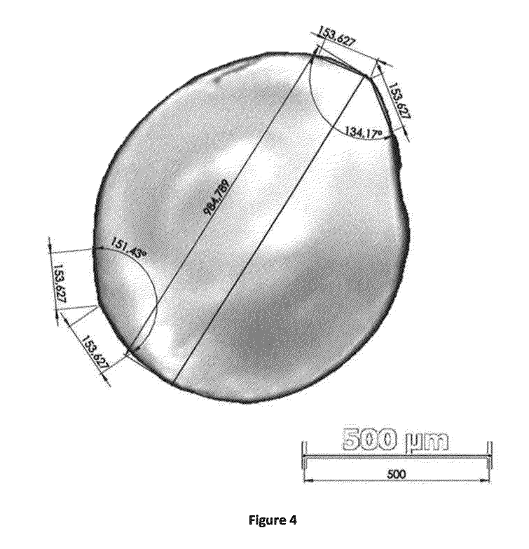

In order to measure the different flowabilities of polymer powder and of spherical microparticles, a transparent box (also termed flow box below) was constructed with internal dimensions 100 mm×100 mm×50 mm; this box has an open top and one side with dimensions 100 mm×50 mm can be opened and closed. On one of the 100 mm×100 mm sides there is an angular scale for the range from 0° to 90° (see FIG. 1).

### Experimental Procedure and Evaluation

For the experiment the flow box is first closed on all sides, and is therefore open only at the top. Substrate (powder or microparticles) is charged via this open face until the material extends beyond the upper edges of the sides. The excess substrate is then leveled off, so that the top of the charge is level with the upper edges of the sides.

One of the sides (face 5, FIG. 1) is then opened so that the substrate flows out of the flow box. This substrate that has flowed out of the box is then collected in a collection vessel. The resultant slip angles differ, depending on the nature of the substrate (see FIG. 1), and these can be read with the aid of the scale. The angles read are indicated by “Slip angle” in Table 1. The substrate remaining in the flow box is then shaken out into a second collection vessel, and weighed. These values are indicated by “Mass of remaining material” in Table 1. Finally, the substrate from the first collection vessel is added to the residual material, and another weighing is carried out. These values are indicated by “total mass” in Table 1.

This experiment is carried out three times for each substrate.

TABLE 1

| | | Spherical | | Powder |
|---|---|---|---|---|
| Experimental | | micro- | Powder | (100 μm to |
| matrix | Variables | particles | (>400 μm) | 400 μm) |
| Experiment 1 | Total mass | 336.80 g | 234.00 g | 216.50 g |
| | Slip angle | 31.00° | 51.00° | 73.00° |
| | Mass of | 99.46 g | 130.00 g | 180.00 g |
| | remaining | | | |
| | material | | | |
| | Proportion | 29.53% | 55.56% | 83.14% |
| | of remaining | | | |
| | material | | | |
| Experiment 2 | Total mass | 339.70 g | 229.60 g | 215.10 g |
| | Slip angle | 31.00° | 44.00° | 73.00° |
| | Mass of | 98.74 g | 109.10 g | 172.00 g |
| | remaining | | | |
| | material | | | |
| | Proportion | 29.07% | 47.52% | 79.96% |
| | of remaining | | | |
| | material | | | |
| Experiment 3 | Total mass | 342.20 g | 238.80 g | 218.20 g |
| | Slip angle | 31.00° | 67.00° | 70.00° |
| | Mass of | 101.98 g | 158.50 g | 153.50 g |
| | remaining | | | |
| | material | | | |
| | Proportion | 29.80% | 66.37% | 70.35% |
| | of remaining | | | |
| | material | | | |
| Average values | Total mass | 339.57 g | 234.13 g | 216.60 g |
| | Slip angle | 31.00° | 54.00° | 72.00° |
| | Mass of | 100.06 g | 132.53 g | 168.50 g |
| | remaining | | | |
| | material | | | |
| | Proportion | 29.47% | 56.48% | 77.82% |
| | of remaining | | | |
| | material | | | |

### Method for Bending Tests

The method for the bending tests was based on DIN EN ISO 14125. For these tests, specimens with edge dimensions 15 mm×100 mm were produced from the organopanels. The distance between the support positions was 80 mm (see FIG. 2). The tests were carried out in a Zwick tensile testing machine as quasi-static bending tests with a test velocity of 2 mm/min. For each material, the arithmetic averages were then calculated from the results of the individual tests (see Table 2 and Table 3). Legend: E_{f} flexural modulus, σ_{fm} flexural strength, ε_{M} tensile strain relating to flexural strength, σ_{fB} flexural stress at break, ε_{M} tensile strain at break.

### Results: T65 XF (Spherical Microparticles) According to the Invention

TABLE 2

| | | | | | | Thick- | Thick- |
|---|---|---|---|---|---|---|---|
| | E_{f} | σ_{fm} | ε_{M} | σ_{fB} | ε_{B} | ness a₀ | ness b₀ |
| | MPa | MPa | % | MPa | % | mm | mm |
| Exper- | | | | | | | |
| iment | | | | | | | |
| No. | | | | | | | |
| 1 | 22797.18 | 272.37 | 2.36 | 200.07 | 3.47 | 1.73 | 15.39 |
| 2 | 23491.86 | 272.94 | 2.09 | 189.46 | 3.22 | 1.72 | 15.32 |
| 3 | 22824.93 | 275.9 | 2.11 | 184.37 | 3.29 | 1.72 | 15.04 |
| 4 | 21787.97 | 260.89 | 2.25 | 162.51 | 4.03 | 1.77 | 15.37 |
| 5 | 22473.14 | 262.08 | 2.23 | 162.47 | 3.14 | 1.73 | 15.2 |
| Series | | | | | | | |
| n = 5 | | | | | | | |
| x trans- | 22675.02 | 268.84 | 2.21 | 179.78 | 3.43 | 1.734 | 15.26 |
| verse | | | | | | | |
| s | 618.92 | 6.86 | 0.11 | 16.77 | 0.36 | 0.02074 | 0.1454 |
| ν | 2.73 | 2.55 | 4.92 | 9.33 | 10.45 | 1.2 | 0.95 |

### Results: T65 XF (Powder) not According to the Invention

TABLE 3

| | | | | | | Thick- | Thick- |
|---|---|---|---|---|---|---|---|
| | E_{f} | σ_{fm} | ε_{M} | σ_{fB} | ε_{B} | ness a₀ | ness b₀ |
| | MPa | MPa | % | MPa | % | mm | mm |
| Exper- | | | | | | | |
| iment | | | | | | | |
| No. | | | | | | | |
| 1 | 23859.66 | 248.9 | 1.45 | 154.65 | 3.28 | 2.12 | 15.66 |
| 2 | 24008.52 | 245.38 | 1.43 | 159.92 | 3.33 | 2.12 | 15.73 |
| 3 | 22627.82 | 242.08 | 1.58 | 145.25 | 4.54 | 2.15 | 15.43 |
| 4 | 22860.69 | 229.76 | 1.44 | 137.85 | 3.24 | 2.15 | 15.68 |
| 5 | 23694.66 | 246.07 | 1.45 | 147.61 | 3.24 | 2.11 | 15.74 |
| 6 | 23216.81 | 240.02 | 1.41 | 148.98 | 3.4 | 2.13 | 15.48 |
| Series | | | | | | | |
| n = 6 | | | | | | | |
| x trans- | 23378.03 | 242.03 | 1.46 | 149.04 | 3.51 | 2.13 | 15.62 |
| verse | | | | | | | |
| s | 563.24 | 6.77 | 0.06 | 7.63 | 0.51 | 0.01673 | 0.1322 |
| ν | 2.41 | 2.8 | 4.08 | 5.12 | 14.58 | 0.79 | 0.85 |

### Characterization of Spherical Microparticles:

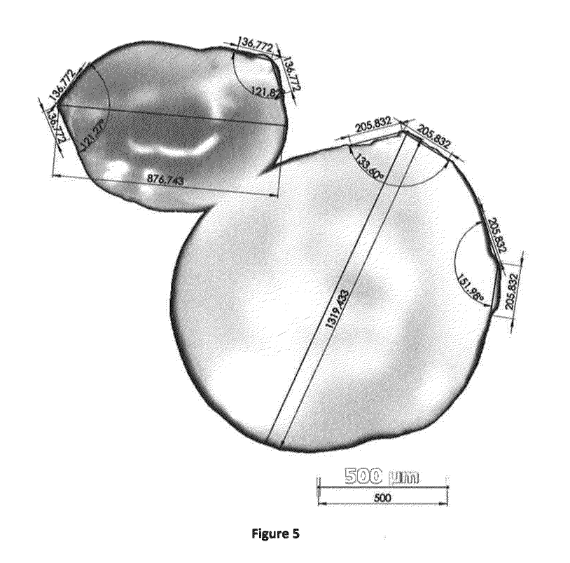

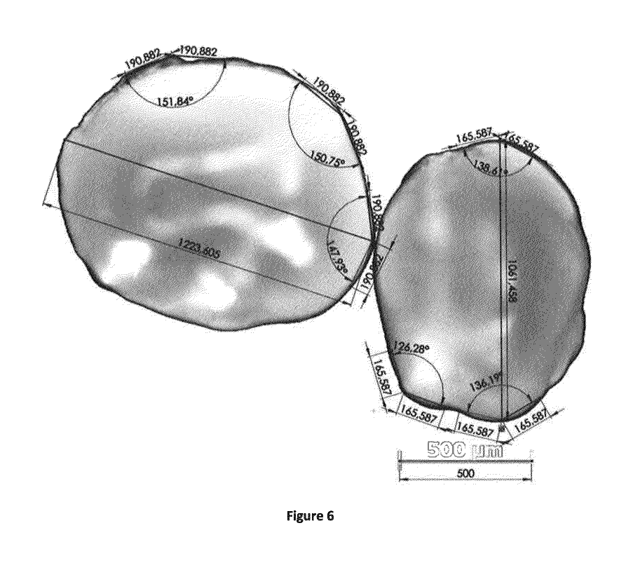

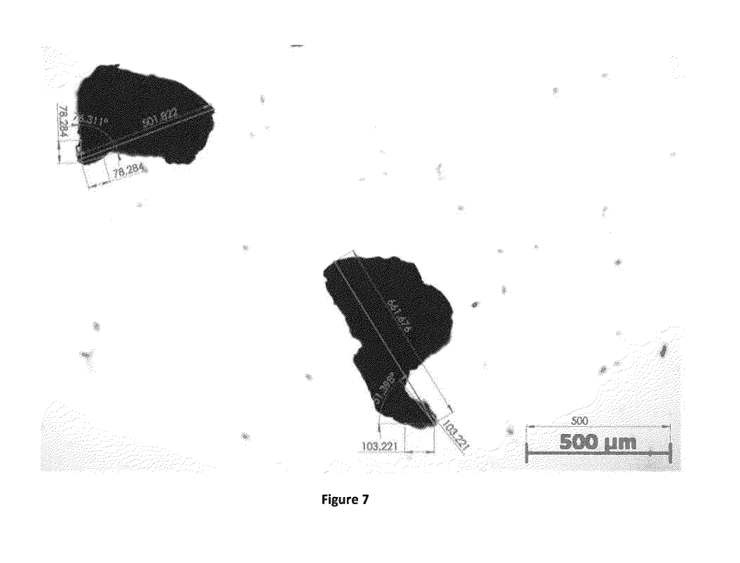

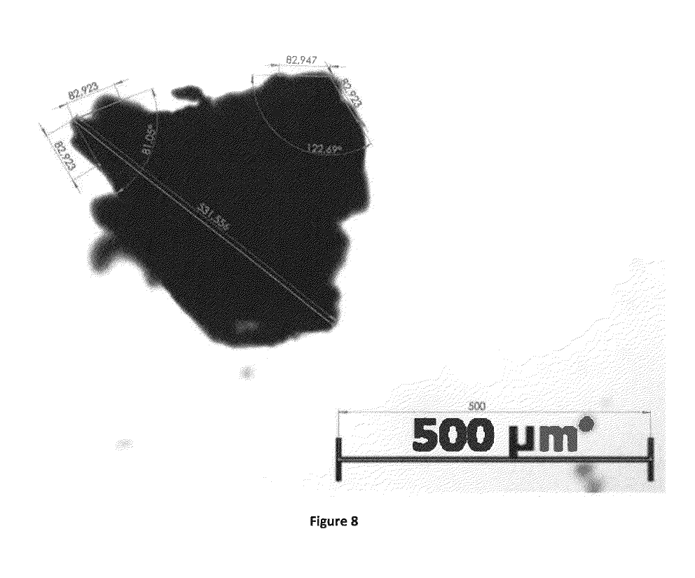

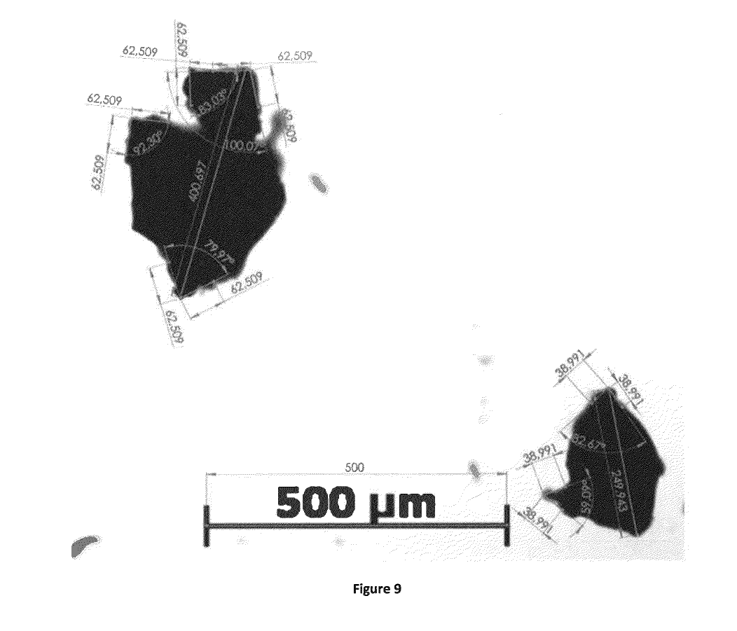

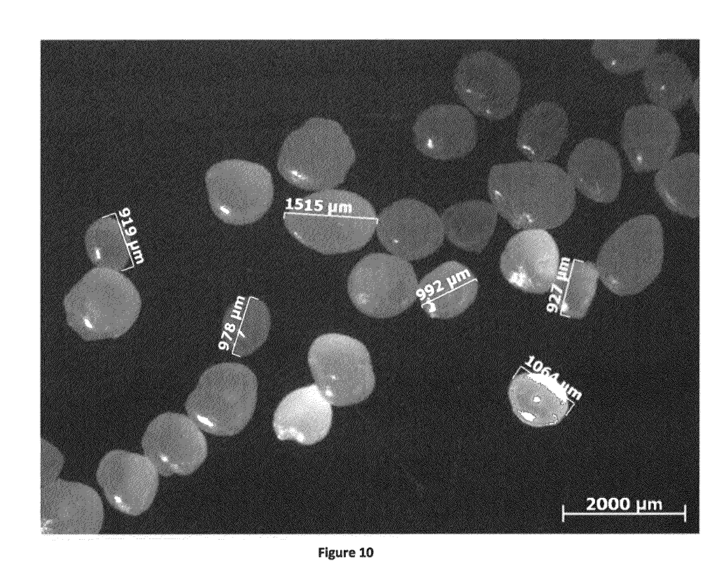

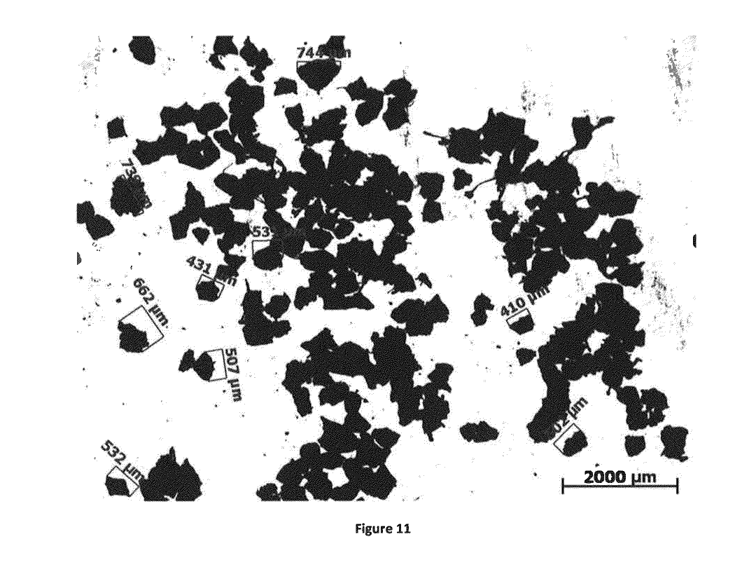

The microparticles and powder particles were characterized by producing micrographs at 50× magnification, using an Axioplan (Zeiss) microscope. The largest dimensions of the particles were first recorded by means of visual evaluation, and image-processing software (Zeiss Axiovision) and CAD Software (Solidworks 2012) were used for quantification. Regions along the outline of the particles were then sought in which the outline exhibits a marked discontinuity or marked curvature. These regions are approximated in each ease by two chords in such a way that the point of intersection of the two chords is as close as possible to the point with the largest curvature. The internal angle formed by the two chords is then measured. This angle is termed outline angle below. Once all of the regions in which a marked discontinuity of the outline of the particles is present have been approximated, the value for the region with the smallest outline angle is taken as the result of the measurement. FIGS. 4 to 9 show examples of particles measured. Table 4 collates the results of all of the measurements.

### Results of Particle Measurement

TABLE 4

| | Outline angle | Smallest outline angle |
|---|---|---|
| Spherical | 134.17° | 134.17° |
| microparticle #1 | 151.43° | |
| Spherical | 121.82° | 121.27° |
| microparticle #2 | 121.27° | |
| Spherical | 133.60° | 133.60° |
| microparticle #3 | 151.98° | |
| Spherical | 151.84° | 147.93° |
| microparticle #4 | 150.75° | |
| | 147.93° | |
| Spherical | 138.61° | 126.28° |
| microparticle #5 | 136.19° | |
| | 126.28° | |
| Powder particle #1 | 76.31° | 76.31° |
| Powder particle #2 | 51.40° | 51.40° |
| Powder particle #3 | 81.05° | 81.05° |
| | 122.69° | |
| Powder particle #4 | 92.30° | 79.97° |
| | 83.03° | |
| | 100.07° | |
| | 79.97° | |
| Powder particle #5 | 82.67° | 59.09° |
| | 59.09° | |

1.-15. (canceled)

16. A process for producing polymer prepregs comprising at least the following steps:
applying microparticles to a woven fibre fabric, laid fibre scrim, fibre non-woven or the like,
melting by introducing heat,
wherein at least 80% of the microparticles have a contour angle of >90°.

17. The process according to claim 16, wherein at least 90% of the microparticles have a contour angle of >90°.

18. The process according to claim 16, wherein at least 95% of the microparticles have a contour angle of >90°.

19. The process according to claim 16, wherein the contour angle of the microparticles is >105°.

20. The process according to claim 16, wherein the contour angle of the microparticles is >120°.

21. The process according to claim 16, wherein at least 80% of the microparticles have a maximum diameter smaller than or equal to 2000 μm.

22. The process according to claim 16, wherein at least 80% of the microparticles have a maximum diameter smaller than or equal to 1700 μm.

23. The process according to claim 16, wherein at least 80% of the microparticles have a maximum diameter smaller than or equal to 1300 μm.

24. The process according to claim 16, wherein at least 80% of the microparticles have a maximum diameter greater than or equal to 100 μm.

25. The process according to claim 16, wherein at least 80% of the microparticles have a maximum diameter greater than or equal to 200 μm.

26. The process according to claim 16, wherein at least 80% of the microparticles have a maximum diameter greater than or equal to 400 μm.

27. A polymer prepreg obtained by the process according to claim 16.

28. A method comprising utilizing the polymer prepreg according to claim 27 for producing composite materials.

29. A process for producing a composite material, wherein at least the following steps are performed:
preparing microparticles, where at least 80% of the microparticles have a contour angle of >90°,
preparing a microparticle prepreg, and
pressing the microparticle prepreg to give a composite material.

30. A composite material obtained by the process according to claim 29.
